(19) United States
(12) Patent Application Publication
(10) Pub. No.: US 2007/0003209 A1
(43) Pub. Date: Jan. 4, 2007

(54) Micro sensor arrays for in situ measurements

(76) Inventors: Ian Papautsky, Mason, OH (US); Jin Hwan Lee, Cincinnati, OH (US); Paul L. Bishop, Cincinnati, OH (US); Fred Beyette JR., Cincinnati, OH (US); Prashant R. Bhadri, Cincinnati, OH (US); Am Jang, Cincinnati, OH (US); William Timmons, Hilliard, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/257,418

(22) Filed: Oct. 24, 2005

Related U.S. Application Data
(60) Provisional application No. 60/621,504, filed on Oct. 22, 2004.

(51) Int. Cl. G02B 6/00

(52) U.S. Cl. 385/147

(57) ABSTRACT

A method is provided for fabricating microelectrodes and microelectrode arrays by etching in an acid solution. Glass wafers are diced into a desired shape to form narrow probes, which are immersed in the acid solution. An organic layer on top of the acid solution forms a meniscus at the point of contact with the probes, and the taper angle on the etched probes will depend on this meniscus angle. After etching, the tapered probes are coated with a conductive layer, followed by an insulating layer over most of their length so as to leave a small conductive area exposed at the tip. The glass wafer containing the probes is then mounted on a printed circuit board carrier.

### CROSS-REFERENCE TO RELATED APPLICATIONS

This application claims the priority of U.S. Provisional Patent Application Ser. No. 60/621,504, filed Oct. 22, 2004, the disclosure of which is incorporated herein by reference.

### FEDERAL FUNDING STATEMENT

This invention was made with Government Support under Contract Nos. IR43ES01 1891-01, 5R43ES011891-02, and 7R43ES011891-03 awarded by the Department of Health and Human Services (National Institutes of Health/National Institute for Environmental Health Sciences). The Government has certain rights in this invention.

### BACKGROUND OF THE INVENTION

The present invention relates to microelectrode sensors and a method for their fabrication.

Many environmental applications require substantial monitoring. Examples include the monitoring of stream or lake sediments, water and wastewater treatment reactors, and water distribution systems. Bioremediation of hazardous waste sites also requires monitoring to ensure that environmental conditions required for remediation of specific toxicants are present, and to verify that pollutant removal is occurring. Monitoring is particularly critical when it is desired to know such things as the oxidation-reduction potential (ORP, also called redox potential), pH, or dissolved oxygen concentrations at the actual point where biodegradation of toxic organics is occurring in the soil or sediment. Knowledge of such parameters is often essential because many chemical or biological reactions only occur under certain ORP, pH, or dissolved oxygen conditions.

One of the most common measurements performed is the measurement of ORP, which measures the tendency of a given system to donate or receive electrons, i.e. become oxidized or reduced. In microbial systems, ORP is primarily determined by the energy-yielding reactions of bacterial cells and is a parameter associated with a dynamic process. ORP provides a useful measurement of the oxidizing or reducing nature of a liquid sample. Various applications include monitoring the chlorination/dechlorination process of water, recognition of oxidants/reductants present in wastewater, or monitoring the cycle chemistry in power plants.

Although many studies have pointed out that ORP can be used as an indication of biological treatment efficiency and water quality, little work of relevance has been done on monitoring soil or sediment biofilm with ORP measurements. One primary reason for this is that traditional monitoring techniques are still based on the laboratory analysis of representative field-collected samples, where measurements are made on samples extracted from the site. The conventional microelectrode sensors used to make these measurements are 1-3 cm in diameter, which is often too large to make the measurements without interfering with the measurement and generally must be used in a highly controlled laboratory setting. They can be used to monitor bulk liquid concentrations when there is sufficient volume to wet the electrode contacts, but are often inappropriate for measurements in small volumes of liquids or in soils. Further, their size makes it impossible to make spatial measurements over small distances, as needed for biofilm monitoring. These traditional methods require considerable efforts, complicated by the fact that the ORP of the sample may change before analysis in the lab, and the results are often not available in due time to allow on-line updating of the process controller.

In the past decade, microelectrodes with tip diameters of 1-10 μm have been widely applied in the field of microbial ecology, giving valuable information on the microscale distribution of oxygen consumption, photosynthesis, sulfate reduction, and nitrification and de-nitrification. However, their fragility, difficulty to manufacture and operate, and susceptibility to electrical interference limit their use to specialized laboratories under highly controlled conditions. Accordingly, there is a need for robust microelectrode sensors that can be used in situ for environmental monitoring. In situ monitoring is also desirable in biofilms and laboratory reactors, both to determine existing environmental conditions and to properly control them.

### SUMMARY

The present invention provides a method for fabricating microelectrode probes and microelectrode probe using a chemical etching technique known as meniscus etching, which utilizes surface tension force at the glass-etchant interface. A glass wafer is diced into the desired shape to form narrow probes, which are immersed into HF-based etchant solution. An organic layer such as vegetable oil is added on top of the etchant to modify contact angle at the glass-etchant interface. The etchant wets the surface of the probes and gradually reduces their dimensions. By slowly withdrawing the glass probes from the etchant at a pre-determined rate, a tapered profile can be obtained on the glass probes. Following etching, the tapered probes are coated with a conductive layer, followed by an insulating layer over most of their length so as to leave a small conductive area exposed at the tip. The glass wafer containing the probes is then mounted on a printed circuit board carrier.

Accordingly, it is a first aspect of the present invention to provide a method of fabricating a microelectrode sensor, including the steps of: (a) providing a glass wafer; (b) dicing the glass wafer to form a diced wafer having at least one probe protruding therefrom; (c) immersing the probe in an etchant solution, the etchant solution supporting an organic layer floating on the surface thereof, where the organic layer forms a meniscus at the point of contact with the probe; (d) withdrawing the probe from the etchant solution at a predetermined rate, whereby the probe develops a tapered profile; (e) re-immersing a tip of the probe in the etchant solution to sharpen the angle of taper at the probe's tip by further etching; (f) depositing a conductive layer on the surface of the probe; and (g) depositing an insulating layer over the conductive layer on the surface of the probe such that the insulating layer does not cover the conductive layer at a relatively small region located at the probe's tip. In a detailed embodiment, the probe's tip following etching has a width of approximately 200 nanometers, and the probe tip has a taper angle of approximately 20 degrees. In another detailed embodiment, the etchant solution comprises HF, HNO₃, and H₂O. In a more detailed embodiment, the ratio by volume of HF:HNO₃:H₂O is approximately 10:7:33. The organic layer can include vegetable oil.

In an another detailed embodiment of the first aspect of the present invention, the depositing step (f) further includes the steps of: (f1) depositing an approximately 30 nanometer-thick later of chromium by evaporation onto the probe; and (f2) depositing an approximately 200 nanometer-thick later of gold by evaporation over the chromium layer on the probe.

In an alternate detailed embodiment of the first aspect of the present invention, the depositing step (g) further includes the steps of: (g1) coating the probe's tip with paraffin; (g2) electrodepositing a layer of polypyrrole on the probe; and (g3) dissolving the paraffin coating on the probe's tip to expose the gold layer on the probe's tip.

In an another detailed embodiment of the first aspect of the present invention, the dicing step (b) further comprises the steps of: (b1) cleaning the glass wafer using a mixture of H₂SO₄ and H₂O₂; (b2) mounting the glass wafer on a soda-lime glass substrate using high melting point wax; (b3) cutting the glass wafer using diamond grit resinoid blades to remove extraneous material, thereby forming a diced wafer; (b4) separating the diced wafer from the soda-lime substrates; (b5) cleaning the diced wafer with Opticlear followed by a mixture of H₂SO₄ and H₂O₂ to clear off any residual wax; and (b6) annealing the diced wafer to relieve stress.

In an another detailed embodiment of the first aspect of the present invention, the method further includes the steps of: (h) forming electrical contact points on a printed circuit board; (i) joining the diced wafer to the printed circuit board such that the probe protrudes from the edge of the printed circuit board carrier; and 0) joining a wire to the probe and the electrical contact point to form a conductive path between the exposed gold layer at the tip of the probe and the electrical contact point. The method can include the additional step of: (k) coupling the printed circuit board to which the diced wafer is joined to a second printed circuit board containing an integrated circuit chip having noise cancellation circuitry for use with the output signal from the probe.

It is a second aspect of the present invention to provide a method of fabricating a microelectrode sensor array, comprising the steps of: (a) providing a glass wafer; (b) dicing the glass wafer to form a diced wafer having a plurality of probes protruding therefrom; (c) immersing the probes in an etchant solution, the etchant solution supporting an organic layer floating on the surface thereof, where the organic layer forms a meniscus at the point of contact with the probes; (d) withdrawing the probes from the etchant solution at a predetermined rate, whereby the probes develop a tapered profile; (e) re-immersing the tips of the probes in the etchant solution to sharpen the angle of taper at each probe's tip by further etching; (f) depositing a conductive layer on the surface of the probes; and (g) depositing an insulating layer over the conductive layer on the surface of the probes such that the insulating layer does not cover the conductive layer at a relatively small region located at each probe's tip. The second aspect of the present invention may be practiced with any of the features or embodiments, or any combination thereof, described above with reference to the first aspect.

It is a third aspect of the present invention to provide a microelectrode array including: a glass wafer having a plurality of probes protruding therefrom, each probe having a tapered profile with a width of between approximately 100 nanometers and 10 micrometers at the tip; a layer of chromium deposited over the surface of each probe; a layer of gold deposited on each probe on top of the chromium layer; and an insulating layer deposited over the gold layer such that the insulating layer does not cover the gold layer at a relatively small region located at each probe's tip.

In a detailed embodiment, the microelectrode array further includes: a first printed circuit board carrier to which the glass wafer is joined such that the probes protrude from the edge of the printed circuit board carrier; a plurality of electrical contact points formed on the surface of the printed circuit board carrier; and a plurality of wires, one end of each wire joined to one of the plurality of probes, and the other end of said wire joined to one of the plurality of electrical contact points to form a conductive path between the exposed gold layer at the tip of the probe and the electrical contact point.

In another detailed embodiment of the third aspect of the present invention, the microelectrode array further includes: a second printed circuit board coupled to the printed circuit board containing the glass wafer, the second printed circuit board having conductive paths electrically coupled to the electrical contact points on the first printed circuit board; and an integrated circuit chip having noise cancellation circuitry for use with the output signal from the probes, the integrated circuit chip being joined to the second printed circuit board such that the integrated circuit is electrically coupled to the conductive paths.

It is a fourth aspect of the present invention to provide a method of fabricating a microelectrode sensor, comprising the steps of: (a) providing a glass wafer; (b) dicing the glass wafer to form a diced wafer having at least one probe protruding therefrom; (c) immersing the probe in an etchant solution, the etchant solution supporting an organic layer floating on the surface thereof, wherein the organic layer forms a meniscus at the point of contact with the probe; (d) withdrawing the probe from the etchant solution at a predetermined rate, wherein the probe develops a tapered profile; and (e) depositing a conductive layer on the surface of the probe.

These and other aspects and embodiments will be apparent from the following description, the accompanying drawings, and the appended claims.

### BRIEF DESCRIPTION OF THE DRAWINGS

FIG. 1 depicts the meniscus etching method of forming a tapered microelectrode probe, according to an exemplary embodiment of the present invention.

FIG. 2 shows the transformation of a glass wafer into a microelectrode array, according to an exemplary embodiment of the present invention.

FIG. 3 is a schematic representation of the apparatus used to perform the etching steps, according to an exemplary embodiment of the present invention.

FIG. 4 depicts the microelectrode array joined to a printed circuit board containing integrated signal processing electronics, according to an exemplary embodiment of the present invention.

FIG. 5 is a schematic representation of an experimental setup used to evaluate the microelectrode array, according to an exemplary embodiment of the present invention.

FIG. 6 is a block diagram illustrating the signal processing steps in the evaluation of the microelectrode array, according to an exemplary embodiment of the present invention.

FIG. 7 show graphs of the electrode response times comparing the performance of the microelectrode array, according to an exemplary embodiment of the present invention, with the performance of a commercial millielectrode and a conventional micro electrode.

FIG. 8 shows a graph of the integrated redox potential of an FF standard solution, as measured by the microelectrode array according to an exemplary embodiment of the present invention, as a function of time.

FIG. 9 shows the standardization curves for the three oxidation-reduction potential probes against three redox standard or reference solutions.

FIG. 10 shows a graph of measured oxidation-reduction potential as a function of pH of the reference solution.

FIG. 11 shows a graph of measured oxidation-reduction potential as a function of time, as the stirring intensity was increased.

FIG. 12 shows graphs of the measured oxidation-reduction potential and temperature of the solution as a function of time.

### DETAILED DESCRIPTION

A. Overview of the Micromachining-By-Etching Process

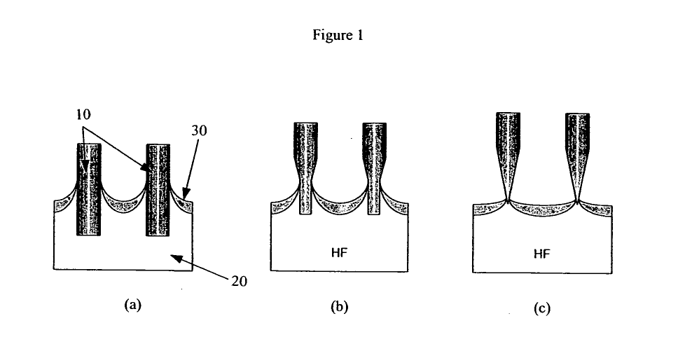

Microelectrode arrays can be fabricated using a chemical etching technique originally developed for sharpening tips of optical fibers in near-field optical microscopy, as described in U.S. Pat. No. 4,469,554, the disclosure of which is incorporated herein by reference. The chemical sharpening process, termed meniscus etching, utilizes surface tension force at the glass-etchant interface. The process is schematically illustrated in FIG. 1. Glass probes 10 are immersed into HF-based etchant 20. An organic layer 30, such as vegetable oil, is added on top of the etchant to modify contact angle at the glass-etchant interface. The etchant wets the surface of the probes and gradually reduces their dimensions. By slowly withdrawing the glass probes 10 from the etchant at a pre-determined rate, a tapered profile can be obtained on the glass probes 10, as illustrated in the progression from FIGS. 1(a) through 1(c), each of which shows the glass probes further removed from the etchant. The surface tension force at the glass-etchant interface reduces with the diminishing dimensions, forcing the height of the meniscus to decrease with time until the etching front reaches the center of the probe and a sharp tip is formed. The balance of the two opposing forces, the surface tension and the weight of the etchant, determines the final tip geometry. Probe spacing and organic layer composition can modify the contact angle at the glass-etchant interface, and consequently the final tip geometry.

The meniscus behavior around an array of axisymmetric probes can be described using the Theory of Capillarity as set forth in J. S. Rowlinson & B. Widom, Molecular Theory of Capillarity, Oxford, U.K., Claredon Press (1982), the content of which is incorporated herein by reference. The fundamental equation that describes the meniscus behavior is given by

$$z ( x ) = x cos ϕ [ ln \frac{4}{x γ \sqrt{Δ ρ g / σ}} + ln \frac{2}{γ \sqrt{Δ ρ g / σ} ( s + a )} ] \qquad ( 1 )$$

where s=\sqrt{a²−x²}, a=\sqrt{l²−4r_{c}²}/2,z(x) is the elevation or depression of the meniscus with respect to the horizontal x direction, y=0.5772 is the Euler-Mascaroni number, Δρ is the density difference between the two fluids making up the interface, g is the acceleration due to gravity, σ is the surface tension of the interface, Φ is the angle made by the tangent to the contact line with the vertical, r_{c} is the radius of either probe, and l is the center-to-center spacing of the array. At large center-to-center probe spacing (>1 mm), the equation reduces to the single probe case. By controlling spacing between probes in an array and by changing the organic layer composition, the tip angle can be adjusted from 6° to 4°.
B. Fabrication Process for the Microelectrode Array

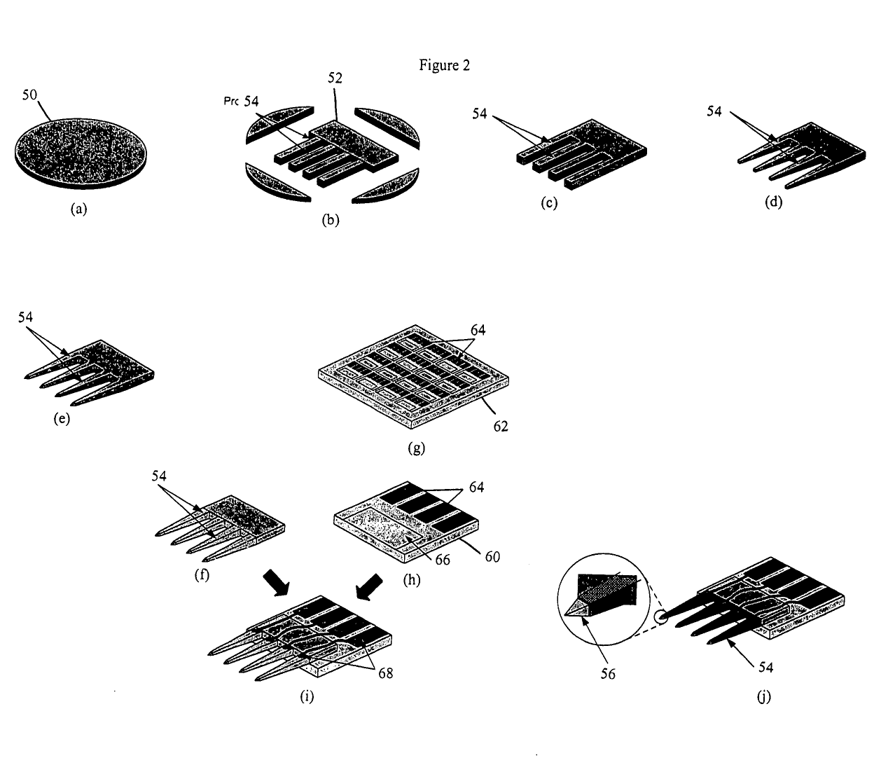

In the exemplary embodiment of the present invention, microelectrode probe arrays are fabricated from 175-μm thick 45 mm×50 mm borosilicate glass wafers. The process has four primary steps: dicing, etching, metallization, and packaging. The process is schematically illustrated in FIG. 2.

1. Dicing

The process begins with a glass wafer 50, as shown in FIG. 2(a). The glass wafer can be cleaned using a 7:3 mixture (volume/volume) of H₂SO₄:H₂O₂ and mounted on a soda-lime glass substrate using high melting point wax (Aremco Products, Inc.). The substrate helps to prevent the glass wafer from splintering while being cut. The wafer is diced, or cut, as depicted in FIG. 2(b) to form a diced wafer 52 containing probes 54 by cutting with a dicing saw at 450 μm center-to-center spacing using 10-mil thick, 45-ltm diamond grit resinoid blades. Other distances for the center-to-center spacing can also be used. In one embodiment, the center-to-center spacing is 900 μm. Wider spacing can be obtained by using a wider blade or by alternately severing every other probe to leave gaps between the remaining probes. The diced wafer 52 containing the probes 54 (as depicted in FIG. 2(c)) is carefully separated from the soda-lime substrates, cleaned with Opticlear (Aremco Products, Inc.) followed by a 7:3 mixture (v/v) of H₂SO₄:H₂O₂ to clear off any residual wax, and annealed at 550° C. for 10 min to relieve stress.

2. Etching

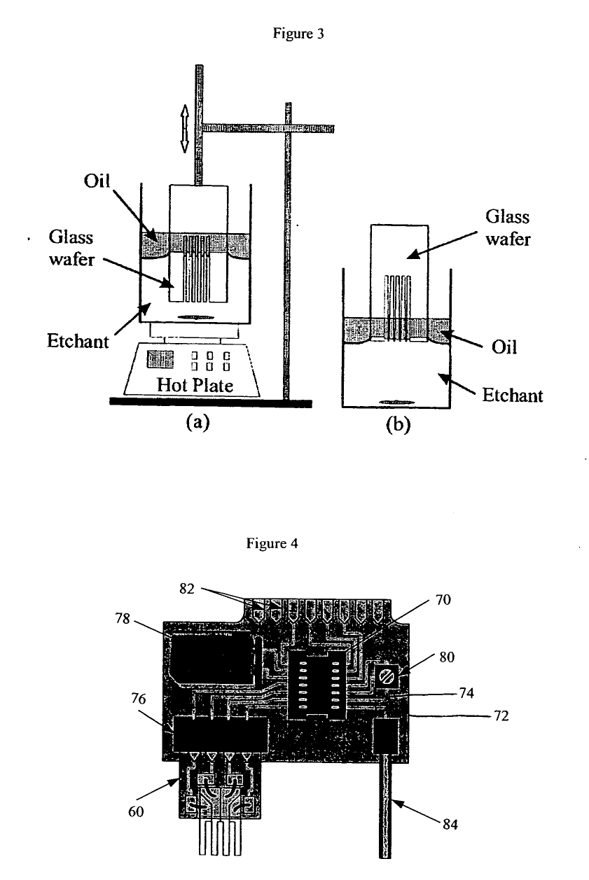

The etching process comprises two steps. The first etch-step serves to reduce the size of the probes and to produce an initial taper of the probe shafts. In this step, as depicted in FIG. 3(a), the glass beams are transformed into microelectrode probes by etching in a 10:7:33 solution (v/v/v) of HF:HNO₃:H₂O for approximately 20 min followed by a gradual withdrawal for 18 min to produce a taper terminating in 20 μm square microelectrode tips. Different mixing ratios can be used for the etchant solution components to achieve different etch rates and taper angles on the probes. A stirring hot plate was used for agitation at 250 rpm and temperature control (25±2° C.) of the etchant. The organic layer of vegetable oil shields the upper section of the microelectrodes from harmful vapors as the array is slowly withdrawn from the etchant solution by a computer-controlled translation stage. At the end of this step, glass probes have a tapered profile (as depicted in FIG. 2(d)) and are reduced to approximately 20 μm square at the tip, at 450 μm center-to-center spacing.

The second etch-step sharpens the tips to approximately 200 nm, as depicted in FIG. 2(e). In this step, as depicted in FIG. 3(b), the 20 μm square tips were immersed to a depth of approximately 1 mm into the same 10:7:33 solution (v/v/v) of HF:HNO₃:H₂O etchant with an organic top layer of vegetable oil. In an exemplary embodiment, the probes would typically be immersed to a depth of between 1 mm and 2 mm during this step, but other depths could be used as well. During this step, no agitation was used. Following etching, the diced wafer 52 containing the probes 54 is cleaned once again using a 7:3 mixture (v/v) of H₂SO₄:H₂O₂.

3. Metallization

In the exemplary embodiment, a 30-nm thick layer of Cr as a seed layer and 200-nm thick layer of Au as a conductive layer are deposited by evaporation to metallize the individual microelectrodes 54, as depicted in FIG. 2(f). Following this metallization of the probes 54, approximately 0.5 to 1 mm of each probe's tip is coated with low-melting-temperature paraffin at approximately 62° C. An approximately 2 μm thick layer of polypyrrole is then electrodeposited on the microelectrodes as protection/insulation layer. The polypyrrole layer can have a thickness in the range from 0.1 μm to 10 μm. Polypyrrole electrodeposition is performed using a 150 mL aqueous solution of oxalic acid (2.7 g) and pyrrole (2.07 mL) as electrolyte and two stainless steel plates (3×5 cm) as cathodes (counter electrodes). The current density was 6 mA/cm². Following electrodeposition, the gold sensing layer was exposed by dissolving the paraffin in Opticlear™ (available from National Diagnostics, Inc.), thus leaving a 0.5 to 1 mm layer of gold exposed at each probe's tip 56, as shown in FIG. 2(j). This exposed gold tip will be the sensing element of the microelectrode.

This steps of coating the gold tips with paraffin, electrodepositing the layer of polypyrrole on the probes, and then dissolving the paraffin can be performed after the diced wafer containing the microelectrode array is mounted on a printed circuit board carrier, as described below. By first mounting the microelectrode array to the printed circuit board carrier, the microelectrode array is far easier to handle during the application of the paraffin and polypyrrole.

In the exemplary embodiment, the array has four microelectrode probes, which permits increased reliability of measurements as data from each of the four microelectrodes can be recorded simultaneously as either individual measurements or averaged into a single measurement. Any number of microelectrodes can be included on the array, however.

4. Packaging

Next, the diced wafer 52 containing the microelectrodes is fixed to a printed circuit board (PCB) carrier 60 for simpler handling and electrical connection. The PCB laminate 62 we used is a copper-clad laminate glass-epoxy measuring 790 μm thick (available from D&L Products, Inc.) with a 35 μm thick layer of copper and a 33 μm thick layer of dry film negative photoresist. Other types of PCBs can be used as well. The copper layer is photolithographically patterned and etched in ferric chloride to define electrical contact points or bond pads 64 on the carrier surface (FIG. 2(g)). Following photolithography, the individual carriers 60 can be cut to size from the patterned board 62 by circuit milling (Quick Circuit 5000, T-Tech) and manually filed down to the desired size (FIG. 2(h)). A diced wafer 52 containing an array of microelectrodes can be fixed to the carrier 60 at point 66 using UV-cured epoxy (Loctite). Conductive silver epoxy (such as Ablebond 8700E, available from Emerson & Cuming) can be used to make electrical connections at points 68 to individual microelectrodes and bond pads 64 (FIG. 2(i)).

C. Integration of Control Electronics with the Microarray

The control electronics for the microelectrode array can be contained on a fully integrated Complementary Metal Oxide Semiconductor (CMOS) based chip system. A CMOS chip is developed for signal acquisition and processing and packaged directly to the microelectrode sensor array to reduce noise. FIG. 4 shows an integrated circuit chip 70 mounted on a printed circuit board 72 containing conductive traces 74. The microelectrode array, which is mounted on the carrier 60, can be joined to the printed circuit board 72 at connector 76. The printed circuit board can also contain a battery 78, an external potentiometer 80 for making adjustments to the noise cancellation, and a connector 82 to enable connection to a personal computer or other data processing device. The components can be further integrated and made even more compact than shown in FIG. 4, for example, by using resistors integrated into the IC chip in place of the external potentiometer 80, and by using a small watch battery. The printed circuit board 72 can also contain the Ag/AgCl reference electrode 84 (as described below for use in making measurements with the microelectrode array), if so desired.

The circuit senses voltages on the microelectrodes in microvolt range with characteristic built-in noise cancellation circuitry. This new circuit design of a CMOS chip is based on the following five distinct signal processing steps: (a) input signal from the probes; (b) low pass filter; (c) unity gain amplifier; (d) instrumentation amplifier; and (e) output voltage to multi-meter. The chip is fabricated using the MOSIS foundry and designed using standard layout design tools using Tanner Tools. The integration of the control circuitry onto the microelectrode array carrier allows for shorter wires and conductive paths than would otherwise be needed, thus lessening the effects of electromagnetic interference.

D. Evaluation of the Microelectrode Array

1. Measurement Setup

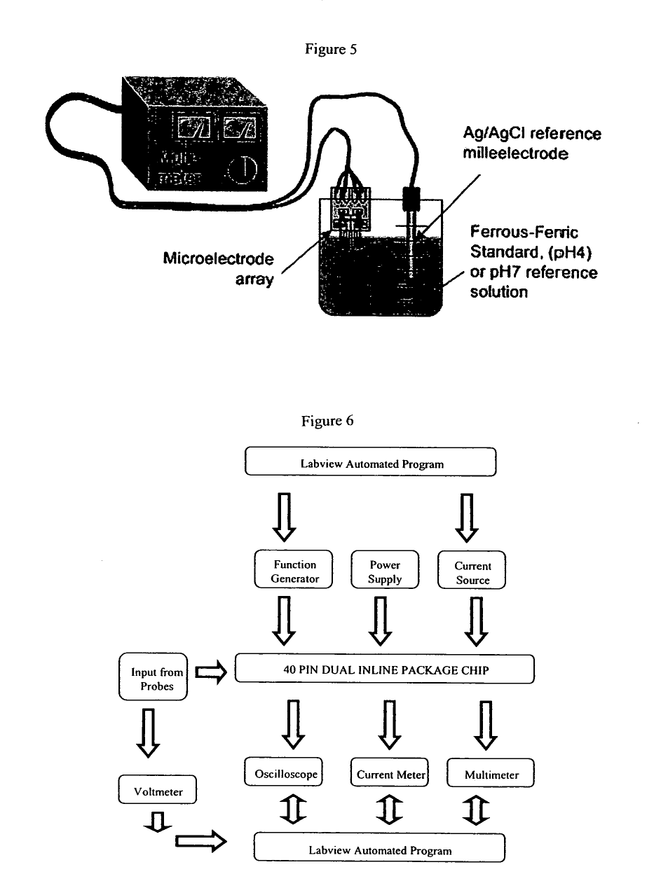

Electrochemical performance of microelectrode array was assessed by measuring redox potentials using the setup schematically shown in FIG. 5. Generally, ORP measurements are based on the potential difference measured between a working electrode made of an inert metal (platinum or gold, as is used on the microelectrodes in the exemplary embodiment) and a reference electrode (which can be made of Ag/AgCl). In our evaluation, we compared the performance of the microelectrode array with that of conventional ORP microelectrodes and commercial electrodes. Four calibration redox solutions, including a ferrous-ferric (FF) standard solution and pH 4, pH 7 and pH 10 buffer reference solutions saturated with quinhydrone (Aldrich, 28,296-0) were used to investigate the performance of the redox probes. When coupled with a Ag/AgCl reference electrode, redox potentials for the pH 7 and pH 4 reference solutions, as recommended by the ASTM (17), should be 92 and 268 mV, respectively, at 20° C.; 86 and 263 mV, respectively, at 25° C. A commercial Ag/AgCl milli-electrode (MI-401, available from Microelectrodes Inc.) was used as the reference electrode. Probes were rinsed with distilled water after use and stored on the shelf. The reference solutions saturated with quinhydrone are susceptible to air oxidation, thus these reference solutions were prepared fresh before each use.

FIG. 6 shows a block diagram of the signal processing used to perform the bench-top experiments using the microarray ORP sensor. The arrows in the figure indicate the direction of the signal flow. The input signal from the probes is fed into the chip, which is integrated with the microarray package, as discussed above. At the same time, the signal is measured using a voltmeter. The characterization of the circuit is performed using the signal from the function generator and current source. The power supply to the chip is provided using 0-5 V and variable bias voltages needed to drive the circuitry. The output from the circuit is monitored by an oscilloscope, current meter and a multi-meter. All the output is monitored using the LABVIEW™ automated measurement software program that controls/monitors chip readings.

2. Performance Results

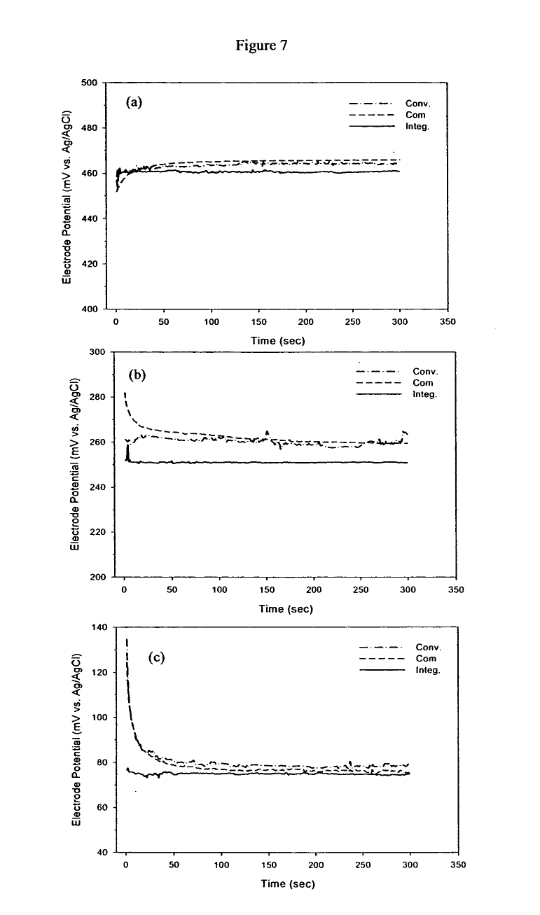

FIGS. 7(a) through 7(c) show graphs of the electrode response times comparing the performance of the integrated microelectrode array of the present invention (labeled “Integ.” in the graphs) with the performance of a commercial millielectrode (labeled “Corn” in the graphs) and a conventional microelectrode (labeled “Conv.” in the graphs). FIGS. 7(a) through 7(c) show the results in a ferrous-ferric (FF) standard solution, a pH 4 quinhydrone reference solution, and a pH 7 quinhydrone reference solution, respectively.

As the graphs of FIG. 7 show, the response times (the time for the electrode to reach 99% of the final stable reading) for the integrated microarray probe of the present invention (“Integ.”) were less than a few milli-seconds for the ferrous-ferric (FF) standard solution , approximately 10 seconds for the pH 4 quinhydrone reference solution, and less than 30 seconds for the pH 7 quinhydrone reference solution. The longer response time for the pH 7 quinhydrone reference solution is partially due to the fact that the number of the final stable reading (74.91±0.41 mV) is small compared to that of the FF standard solution (460.68±0.31 mV). Under the same conditions, the response times for the commercial milli-electrode (“Com”) were 2 minutes for the FF standard solution, about 5 minute for the pH 4 quinhydrone reference solution, and more than 10 minutes for the pH 7 quinhydrone reference solution. Therefore, the time for the redox potential microelectrode to reach 90% of the final stable reading was used. The time for the commercial milli-electrode to reach 90% of the final stable reading for pH 7 quinhydrone reference solution was 2 minutes. Under the same conditions, the response times for the integrated microelectrode were only a few seconds. Therefore, these results indicate that the integrated redox potential microelectrode has a much shorter response time than either the conventional microelectrode or the commercial milli-electrode.

FIG. 7 also indicates that prior readings of integrated microelectrode, compared to the both commercial electrode and conventional microelectrode have no effect on the reading of the following sample. It was found that the gold sensing layer at the tip coated by low melting temperature paraffin at 62° C. was inert enough that the microelectrode has no memory of the redox potential measured previously. This is also an important check to determine whether the ORP microelectrode is in good condition.

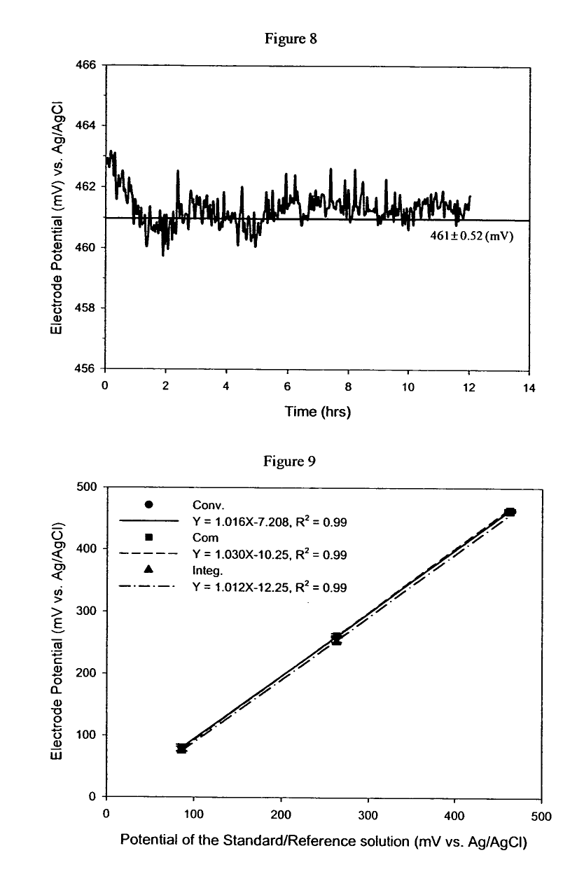

To check the stability of the integrated microarray probe for long time measurements, the FF standard solution was used because the quinhydrone reference solutions are not stable for more than a few hours. The profiles of the integrated redox potential in FIG. 8 reveal that the measured ORP decreased gradually but showed a stable potential response with only a slight fluctuation (±1 mV) after 3 hours. The most common problem reported with regard to ORP determination in environmental aqueous samples is that readings can differ by a significant margin (50-100 mV), even though the sensors are in the same solution. Here, though, the integrated ORP probe gave a very stable voltage response (the corresponding rate of the integrated microelectrode potential change was in the range of only 0.6-1.1 mV/min) even when the measurement was carried out outside the Faraday cage where signals could have been inhibited by external factors such as static electricity or vibrations. The integrated microarray probe had a response voltage in the range of 461±0.52 mV.

After selecting the stable probes, the following experiment was conducted. Unlike dissolved oxygen and other ion-specific electrodes that measure a current or potential that is proportional to the concentration of the chemical species in a solution, an ORP electrode only measures directly the potential (in mV) of the solution itself (a single point calibration). Thus, an ORP electrode merely measures the ratio of oxidized to reduced forms of all chemical species in solution. Therefore, an ORP electrode or microelectrode cannot be calibrated in the conventional sense, like sensors for pH measurement, for example. It is, however, standard practice to check the electrode response against standard and reference redox potential solutions for proper operation. In this study, in order to evaluate whether the fabrication procedure produces a good redox potential probe, the response of the redox potential microelectrode was first checked against three redox potential standard or reference solutions and then compared with the responses of both the conventional microelectrode and the commercial milli-electrode. As shown in Table 1, the nominal redox potential of the FF standard solution with an Ag/AgCl reference electrode containing 3 M KCl at 25° C. is 463 mV. The nominal redox potential of pH 4 and pH 7 quinhydrone reference solutions with Ag/AgCl reference electrode at 25° C. are 263 and 86 mV, respectively. At 23° C. these values should be slightly (approximately 1-2 mV) higher. The measured redox potentials of the integrated redox potential probe with respect to the Ag/AgCl reference electrode and 3 M KCl at 23° C. were 460.68±0.31 mV for FF standard solution, 251.10±0.49 mV for pH 4 quinhydrone reference solution, and 74.91±0.418 mV for pH 7 quinhydrone reference solution, respectively. The measured ORPs using the three kinds of redox potential probes were typically slightly lower than those of the nominal redox potential. ASTM suggests that the measured redox potentials should be within 10 mV of the nominal redox potentials for a good redox electrode. Thus, all of the measurements should be deemed acceptable.

TABLE 1

| | Nominal Redox Potential¹ | | | Measured Redox Potential ² (mV) | | |
|---|---|---|---|---|---|---|
| Redox Standard or | (mV) | | | Conventional | Commerical | Integrated |
| Reference Solution | 20° C. | 23° C. | 25° C. | microelectrode | milli-electrdoe | microelectrode |
| Ferrous-Ferric | | | 463 | 463.62 ± 1.22 | 464.69 ± 2.15 | 460.68 ± 0.31 |
| Standard Solution | | | | | | |
| pH 4 Quinhydrone | 268 | 265 | 263 | 260.26 ± 1.55 | 262.20 ± 3.19 | 251.10 ± 0.49 |
| reference solution | | | | | | |
| pH 7 Quinhydrone | 92 | 88.4 | 86 | 80.20 ± 5.56 | 78.30 ± 3.94 | 74.91 ± 0.41 |
| reference solution | | | | | | |

¹ Compiled from ASTM D1498-93. The values for 23° C. and for 3 M KCl are derived by interpolation from Table 2 and 3 in that document. ASTM (D1498-93) suggests two redox reference solutions: pH 4 and pH 7 quinhydrone reference solutions.
² Each value of the measured redox potential is the average of the electrode potential readings within 1% of the final potential reading of that electrode. A Ag/AgCl reference electrode with 3 M KCl was used during the calibrations. The temperature during the calibrations was 23° C.

There are two ways to calibrate an ORP-measuring device. The two-point calibration procedure is the recommended procedure to set the slope of the ORP electrode, but sometimes it may be necessary to perform a single point standardization. FIG. 9 shows the standardization curves for the three ORP probes against three redox standard or reference solutions. The slopes of the three curves (1.016 for the conventional microelectrode, 1.030 for the commercial milli-electrode, and 1.012 for the integrated probe) are quite close to the theoretical value of 1.00. The comparison shows that the integrated microelectrode has the same or more accurate readings than the other two electrodes.

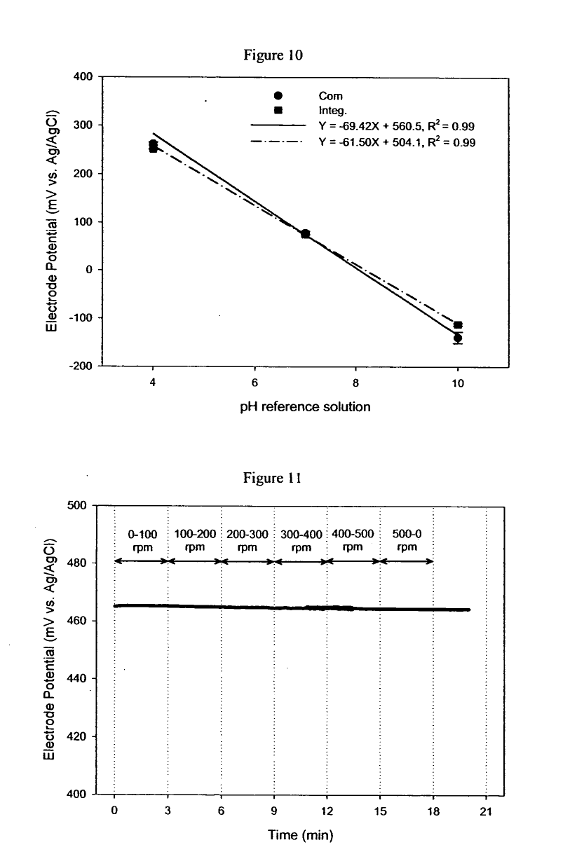

ASTM suggests (as set forth in Standard Practice for Oxidation-Reduction Potential of Water; D 1498-00; In 1993 Annual Book of ASTM Standards; American Society for Testing and Materials (ASTM), 1993) two redox reference solutions (pH 4 and pH 7 quinhydrone reference solutions); no redox reference solution with negative potential has been established, probably due to, problems associated with air oxidation. Other chemicals for negative potential, such as sodium thioglycolate, have been suggested but have not been standardized. In our work, the reference solutions contain solid quinhydrone which, when added to the supplied buffers, yield three solutions (pH 4, pH 7, and pH 10) which well-defined, but different, ORP values. As shown in FIG. 10, the ORP value was found to be correlated to the logarithm of the hydrogen concentration with a linear relationship. Error bars represent the standard deviation for data collected over the application times. The integrated ORP probe showed a log-linear ORP response down to a hydrogen concentration of 10⁻¹⁰ M. The redox potential of the integrated ORP probe and the commercial milli-electrode were in the negative ORP range of −112.25±2.4 and −139.5±11.87 mV in pH 10 reference solution, respectively. The redox potentials of the two reference solutions (pH 4 and pH 7 quinhydrone reference solutions) was listed in Table 1. Pang and Zhang reported that the ideal slope (Δ redox potential/Δ pH unit) calculated from these reference solutions was 59 mV/pH unit. Pang, H.; Zhang, T. C. Fabrication of redox potential microelectrodes for studies in vegetated soils or biofilm systems. Environ. Sci. & Tech. 1998, 32(22), 3646-3652. The slope of the integrated microelectrode (61.5 mV/pH) was close to the ideal slope.

The effect of mixing on ORP measurements was also investigated. The experiment was carried out by sequentially inserting the integrated microelectrode into standard ORP solutions using five different stirring velocities. As shown in FIG. 11, the redox potential profile exhibited a trend of a very gradual decrease, as stirring intensity increased. The slightly unstable potential profile between 300-500 rpm occurred when the stirring bar began bumping the beaker wall. Even with this additional turbulence, the measured ORP variability was less than 1 mV. Thus it can be concluded that the signal was not influenced by stirring.

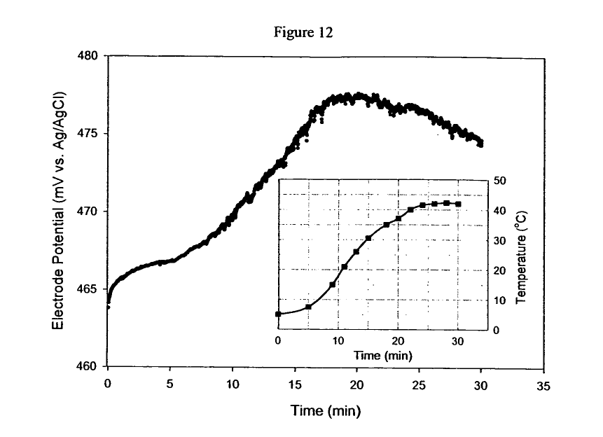

Temperature changes can cause variation in ORP measurements. This factor definitely needs to be taken into account for calibration and should be considered when reporting ORP values. The ORP measurement is governed by the Nernst equation:

$$E = E ° + 2.3 \frac{RT}{nF} ( log \frac{{A}_{ox}}{{A}_{red}} )$$

where E is the potential developed at the metal electrode surface coupled with an Ag/AgCl reference electrode (mV); E° is the constant dependent on the reference electrode (mV); R is the universal gas constant; T is the absolute temperature in degrees Kelvin (K); n is the number of electrons involved in the equilibrium between the oxidized and reduced species; F is the Faraday constant (96500 coulombs); Aₒₓ is the activity of the oxidized species; and A_{red} is the activity of the reduced species. As can be seen from examination of the Nernst equation, the ORP is dependent on temperature. The temperature of the FF standard solution for which the integrated ORP probe was determined was found to slightly affect the voltage output of the probe. It is shown in FIG. 12 that the ORP changes were proportional to the increased temperature. In contrast, ORP profiles obtained under the steady or increasing temperature between 20 and 30 minutes showed a little reduced ORP (less than 2 mV). One possible reason was that the properties of FF standard solution might be changed due to higher temperature (35° C.). Increasing temperature affects on ion activity, such as activity coefficients and interactions between ions in solution. Between 5 to 40° C., the mean changes in the signal per ° C. were less than 3%. This result indicates that although the effect of temperature on the integrated ORP probe is small, neglecting to record the temperature with every ORP measurement might lead to error and lack of reproducibility.

Potential Application of Integrated ORP Microelectrode Array. As described in Standard Methods for the Examination of Water and Wastewater (Section 2580 B.) (Standard Methods for the Examination of Water and Wastewater, 20^{th} edition; American Public Health (APHA) American Water Works Association and Water Environment Federation: Washington D.C., USA, 1998), oxidation-reduction potential (ORP) is a potentiometric measurement of the tendency of a given system to donate or receive electrons, i.e. to become oxidized or reduced. Although some pioneering studies have already pointed out that ORP measurements can be powerfully used to control the aeration in biological treatment process and water quality monitoring, up to now few reports can be found on the application of ORP electrode for the monitoring of soil or sediment pore water, groundwater, and other systems.

To date, many of these measurements have been made using traditional chemical electrodes that are relatively large, on the order of 1-3 cm in diameter. These large electrodes can be used to monitor bulk liquid concentrations when there is sufficient volume to wet the electrode contacts, but they are often inappropriate for measurements in small volumes of liquids or in soils. Further, their size makes it impossible to make spatial measurements over small distances, as needed for biofilm monitoring. It was reported that using separate reference and working microelectrodes were good for laboratory measurements and were relatively easy to fabricate. Bishop, P. L.; Yu, T. A microelectrode study of redox potential change in biofilms. Wat. Sci. Tech. 1999, 39(7), 179-185. However, the drawback of conventional separate microelectrodes is that their use requires good shielding and grounding systems to minimize electrical interference. In order to overcome the shortcomings of the conventional microelectrode systems described above, a new redox potential microelectrode for in situ environmental monitoring has been successfully developed in this study. These new integrated microelectrodes were easier to fabricate and were more robust than the conventional micro electrodes.

The potential (or tendency) of the medium for electron transfer was sensed by a microelectrode made of an inert metal (gold) and read relative to a Ag/AgCl reference electrode that was immersed in the same standard solutions. The readout of the sensor versus the Ag/AgCl reference electrode was a voltage, with positive values indicating an oxidizing environment (ability to accept electrons) and negative values indicating a reducing environment (ability to furnish electrons). The functionality of a CMOS chip connected with the sensors was to detect small voltage changes outside of a Faraday cage by eliminating environmental and instrumental noise. The objective of building a robust system which is immune to noise is built by taking care of the design issues both at the design level and at circuit level. The input voltage signal from the Micro-Electrode-Array (MEA) is fed into the low pass filter, which removes extraneous noise coupled with the signal to be measured. The filtered signal is an input to the isolation or buffer amplifier. The output signal of the buffer amplifier is sourced into a fully differential output instrumentation amplifier, which is the gain adjusting stage through a single variable resistor. This differential instrumentation amplifier is the design methodology used in minimizing the effects of environmental noise. Differential measurement rejects noise common to both the inputs. The high common mode signal rejection ratio of this amplifier improves the signal to noise ratio. The output voltage of the differential amplifier is passed through a buffer stage. This output voltage is a measure of ORP of the solution. The major advantage of this design is that the signal is amplified very close to the microelectrode and the integrity of the signal is preserved. This system design approach used was able to stabilize the output signal and enhance the signal to noise Ratio which is one of the performance metrics in measuring low analog signals.

The new microelectrodes were fully characterized using standard solutions and were shown to exhibit better signal stability. Moreover, the speed of ORP response time of the integrated microelectrode was sufficiently fast for rapid measurement or control. Provide that these new microelectrodes can be made robust enough to use in the environment to evaluate in situ conditions, their accuracy, precision, freedom from electrical interference problems and very small size could lead to the development of a major new monitoring technique.

With further development, it may be possible to use the new integrated microelectrode to obtain direct information from measurements inside heterogeneous biological system, i.e., the distribution of organisms and kinetic parameters. In addition, remediation of Superfund and other hazardous waste sites, particularly those using bioremediation techniques, requires the significant use of monitoring procedures. This is necessary to ensure that environmental conditions required for bioremediation of specific toxicants are present, and to verify that pollutant removal is occurring. In most cases, measurements made on samples extracted from the site are not acceptable. Microscale in situ measurement of various constituents in aqueous and soil environments is essential for proper monitoring of environmental conditions at a specific location and to determine impacts of environmental stressors. In situ monitoring is also required in laboratory reactors, both to determine existing environmental conditions and to properly control them.

Having described the invention with reference to exemplary embodiments, it is to be understood that the invention is defined by the claims and it is not intended that any limitations or elements describing the exemplary embodiment set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method of fabricating a microelectrode sensor, comprising the steps of:
(a) providing a glass wafer;
(b) dicing the glass wafer to form a diced wafer having at least one probe protruding therefrom;
(c) immersing the probe in an etchant solution, the etchant solution supporting an organic layer floating on the surface thereof, wherein the organic layer forms a meniscus at the point of contact with the probe;
(d) withdrawing the probe from the etchant solution at a predetermined rate, wherein the probe develops a tapered profile;
(e) re-immersing a tip of the probe in the etchant solution to sharpen the angle of taper at the probe's tip by further etching;
(f) depositing a conductive layer on the surface of the probe; and
(g) depositing an insulating layer over the conductive layer on the surface of the probe such that the insulating layer does not cover the conductive layer at a relatively small region located at the probe's tip.

2. The method of claim 1, wherein
during the second immersing step (e), the probe's tip is immersed in the etchant solution to a depth of between approximately 1 millimeter and 2 millimeters.

3. The method of claim 1, wherein
after the second immersing step (e), the probe's tip has a width of approximately 200 nanometers.

4. The method of claim 3, wherein
after the second immersing step (e), the probe's tip has an angle of taper of approximately 20 degrees.

5. The method of claim 4, wherein
The probe has a length of approximately 2 centimeters.

6. The method of claim 1, wherein
the etchant solution comprises a mixture of HF, HNO₃, and H₂O.

7. The method of claim 6, wherein
the ratio by volume of HF:HNO₃:H₂O is approximately 10:7:33.

8. The method of claim 6, wherein
the etchant solution is maintained at a temperature of approximately 25 degrees Celsius.

9. The method of claim 1, wherein
the organic layer comprises vegetable oil.

10. The method of claim 1, wherein
prior to the withdrawing step (d), the probe is immersed in the etchant solution for approximately 20 minutes; and wherein
the withdrawing step (d) is performed during a period of approximately 18 minutes.

11. The method of claim 1, wherein
the first immersing step (c) and the withdrawing step (d) further comprise the step of agitating the etchant solution using a stirring hot plate.

12. The method of claim 11, wherein the stirring hot plate is operated at a speed of approximately 250 rpm.

13. The method of claim 1, wherein
the depositing step (f) further comprises the steps of:
(f1) depositing an approximately 30 nanometer-thick later of chromium by evaporation onto the probe; and
(f2) depositing an approximately 200 nanometer-thick later of gold by evaporation over the chromium layer on the probe.

14. The method of claim 1, wherein
the depositing step (g) further comprises the steps of:
(g1) coating the probe's tip with paraffin;
(g2) electrodepositing a layer of polypyrrole on the probe; and
(g3) dissolving the paraffin coating on the probe's tip to expose the gold layer on the probe's tip.

15. The method of step 1, wherein.
the glass wafer is a borosilicate glass wafer.

16. The method of claim 1, wherein
the dicing step (b) further comprises the steps of:
(b1) cleaning the glass wafer using a mixture of H₂SO₄ and H₂O₂;
(b2) mounting the glass wafer on a soda-lime glass substrate using high melting point wax;
(b3) cutting the glass wafer using diamond grit resinoid blades to remove extraneous material, thereby forming a diced wafer;
(b4) separating the diced wafer from the soda-lime substrates;
(b5) cleaning the diced wafer with Opticlear followed by a mixture of H₂SO₄ and H₂O₂ to clear off any residual wax; and
(b6) annealing the diced wafer to relieve stress.

17. The method of claim 1, further comprising the steps of:
(h) forming electrical contact points on a printed circuit board;
(i) joining the diced wafer to the printed circuit board such that the probe protrudes from the edge of the printed circuit board carrier; and
(j) joining a wire to the probe and the electrical contact point to form a conductive path between the exposed gold layer at the tip of the probe and the electrical contact point.

18. The method of claim 17, further comprising the steps of:
(k) coupling the printed circuit board to which the diced wafer is joined to a second printed circuit board containing an integrated circuit chip having noise cancellation circuitry for use with the output signal from the probe.

19. A method of fabricating a microelectrode sensor array, comprising the steps of:
(a) providing a glass wafer;
(b) dicing the glass wafer to form a diced wafer having a plurality of probes protruding therefrom;
(c) immersing the probes in an etchant solution, the etchant solution supporting an organic layer floating on the surface thereof, wherein the organic layer forms a meniscus at the point of contact with the probes;
(d) withdrawing the probes from the etchant solution at a predetermined rate, wherein the probes develop a tapered profile;
(e) re-immersing the tips of the probes in the etchant solution to sharpen the angle of taper at each probe's tip by further etching;
(f) depositing a conductive layer on the surface of the probes; and
(g) depositing an insulating layer over the conductive layer on the surface of the probes such that the insulating layer does not cover the conductive layer at a relatively small region located at each probe's tip.

20-36. (canceled)

37. A microelectrode array comprising:
a glass wafer having a plurality of probes protruding therefrom, each probe having a tapered profile with a width of between approximately 100 nanometers and 10 micrometers at the tip;
a layer of chromium deposited over the surface of each probe;
a layer of gold deposited on each probe on top of the chromium layer; and
an insulating layer deposited over the gold layer such that the insulating layer does not cover the gold layer at a relatively small region located at each probe's tip.

38-43. (canceled)
